(19) United States
(12) Patent Application Publication
(10) Pub. No.: US 2011/0284807 A1
(43) Pub. Date: Nov. 24, 2011

(54) METAL FINE PARTICLE, CONDUCTIVE METAL PASTE AND METAL FILM

(75) Inventors: Dai ISHIKAWA, Hitachi (JP); Tomiya ABE, Hitachi (JP)

(73) Assignee: HITACHI CABLE, LTD., Tokyo (JP)

(21) Appl. No.: 12/963,121

(22) Filed: Dec. 8, 2010

(30) Foreign Application Priority Data
May 21, 2010 (JP) 2010-117384

(51) Int. Cl. H01B 1/22

(52) U.S. Cl. 252/512

(57) ABSTRACT

A metal fine particle includes one amine compound, and one compound causing an alkylation of the amine compound. The amine compound and the alkylation causing compound cover a surface of the metal fine particle. The alkylation causing compound includes an alkyl halide compound. The alkyl halide compound includes one of iodomethane, iodoethane, 1-iodopropane, 2-iodopropane, 1-iodobutane, 1-iodo-2-methylpropane, 1-iodopentane, 1-iodo-3-methylbutane, 1-iodohexane, 1-iodoheptane, 1-iodooctane, 1-iodononane, 1-iododecane, 1-iodoundecane, 1-iodododecane, 1-iodotridecane, 1-iodotetradecane, 1-iodopentadecane, 1-iodohexadecane, 1-iodoheptadecane, 1-iodooctadecane, 1-iodononadecane, and 1-iodoeicosane.

The present application is based on Japanese Patent Application No. 2010-117384 filed on May 21, 2010, the entire contents of which are incorporated herein by reference.

### BACKGROUND OF THE INVENTION

1. Field of the Invention

The invention relates to a metal fine particle whose surface is coated with a protective agent including an amine compound. The invention also relates to a conductive metal paste including the metal fine particle, and a metal film formed with the conductive metal paste.

2. Description of the Related Art

A conductive metal paste is a paste composition composed of a metal fine particle, a protective agent for coating the surface thereof and a solvent composition, and is a material which exhibits high conductivity by calcination.

A metal fine particle means a minute metal particle having a particle size of about 1-100 nm, and a phenomenon that a melting point is depressed due to a rapid increase in a surface area with respect to particle volume of the metal fine particle is known. Therefore, diffusion of the metal fine particles at an interface between particles occurs at a temperature lower than the melting point of bulk metal, and a metal bond is formed by progression of fusion (non-patent literary document 1: Ink-jet Wiring of Fine Pitch Circuits with Metallic Nano Particle Pastes, published by CMC Publishing CO., LTD. in 2006).

A simple metal fine particle is very unstable, and aggregation or fusion of metal fine particles proceeds even at around room temperature. Therefore, it is essential to suppress the aggregation or fusion of metal fine particles by coating the surface thereof with an organic substance called protective agent which exhibits adsorption properties, and a surface of a metal fine particle used for conductive metal paste is also coated with a protective agent (non-patent literary document 1).

Many of protective agents have a chemical structure with a functional group including an atom such as a sulfur atom (S), a nitrogen atom (N) and an oxygen atom (O). The atom of S, N or O, etc., has an unshared electron pair and can be coordinatively adsorbed to metal by an effect of the unshared electron pair. In detail, a compound having a structure with a functional group such as a thiol group (—SH), an amine group (—NH) and a carboxyl group (—COOH) is used as a protective agent.

A conductive metal paste composed of metal fine particle coated with a protective agent and a solvent composition allows calcination at low temperature to form a conductive film (metal film) due to melting point depression of the metal fine particle. However, there is a problem that an organic substance derived from the protective agent or the solvent composition is likely to remain in the conductive film. Specifically, the protective agent remaining on the surface of the metal fine particle inhibits contact and fusion of the metal fine particles, which significantly decreases conductivity of the metal film. The protective agent on the metal fine particle is eliminated or burnt by continuous calcination at high temperature for long time and can be released from the metal film, however, conductive metal paste is generally used for manufacturing a metal film by calcination at low temperature for short time, and thus, the remained protective agent arises a problem.

Following conventional arts exist in order to overcome the problem of the protective agent which remains. A means of adding acid anhydride or organic acid which has reactivity with an amine-based protective agent is used to actively remove the protective agent (WO2002-035554). Meanwhile, there is a means in which both of an amine compound and a carboxyl compound are used as a protective agent for synthesizing metal fine particle and to coat the surface thereof (JP-A-2007-63580 and JP-A-2009-62611). The design concept of these conventional arts is to actively remove the protective agent from the surface of the metal fine particle by producing amide, etc., using reaction of an amine compound with acid anhydride, organic acid or a carboxyl compound during calcinations.

### SUMMARY OF THE INVENTION

However, the problem of the above-mentioned conventional art is that sufficiently high conductivity is not necessarily obtained. It is because an amide compound (amide structure/bond: —CONH—) produced by a reaction of an amine-based protective agent with organic acid (including acid anhydride and a carboxyl compound) is not sufficiently eliminated from the surface of the metal fine particle. Since N or O having an unshared electron pair is present in the amide structure, some amide compounds adsorbed on the surface of the metal fine particle remains. That is, it is inherently difficult to remove a component of the protective agent from the surface of the metal fine particle in the above-mentioned chemical reaction of the conventional art since N or O forms a compound having an unshared electron pair when the protective agent is reacted.

It is an object of the invention to provide a metal fine particle which allows an amine compound as a protective agent to be promptly eliminated by calcination at low temperature for short time, a conductive metal paste including the metal fine particle and a metal film formed of the conductive metal paste.

(1) According to one embodiment of the invention, a metal fine particle comprises:

one amine compound; and

one compound causing an alkylation of the amine compound,

wherein the amine compound and the alkylation causing compound cover a surface of the metal fine particle.

In the above embodiment (1) of the invention, the following modifications and changes can be made.

(i) The alkylation causing compound comprises an alkyl halide compound.

(ii) The alkyl halide compound comprises one of iodomethane, iodoethane, 1-iodopropane, 2-iodopropane, 1-iodobutane, 1-iodo-2-methylpropane, 1-iodopentane, 1-iodo-3-methylbutane, 1-iodohexane, 1-iodoheptane, 1-iodooctane, 1-iodononane, 1-iododecane, 1-iodoundecane, 1-iodododecane, 1-iodotridecane, 1-iodotetradecane, 1-iodopentadecane, 1-iodohexadecane, 1-iodoheptadecane, 1-iodooctadecane, 1-iodononadecane, and 1-iodoeicosane.

(iii) The metal fine particle comprises an average particle size of 1 to 100 nm.

(2) According to another embodiment of the invention, a conductive metal paste comprises:

the metal fine particle according to the above embodiment (1); and a solvent.

(3) According to another embodiment of the invention, a conductive metal paste comprises:

the metal fine particle according to the above embodiment (1);

a silver oxide particle; and

a solvent.

(4) According to another embodiment of the invention, a metal film formed with the conductive metal paste according to the above embodiment (2).
(5) According to another embodiment of the invention, a metal film formed with the conductive metal paste according to the above embodiment (3).

### POINTS OF THE INVENTION

According to one embodiment of the invention, a metal fine particle is formed such that the surface thereof is coated with an amine compound (protective agent) and a compound (i.e., alkylating agent) causing alkylation of the amine compound, so that the amine compound is alkylated by the heat of calcination and the amine compound as a protective agent is easily eliminated from the surface of the metal fine particle. Therefore, the metal fine particle can be used to form a metal film with low resistivity.

### BRIEF DESCRIPTION OF THE DRAWINGS

Next, the present invention will be explained in more detail in conjunction with appended drawings, wherein:

FIG. 1A is a table showing a composition of metal fine particle, a component of conductive metal paste, and calcination conditions and characteristics of metal film in Examples; and

FIG. 1B is a table showing a composition of metal fine particle, a component of conductive metal paste, and calcination conditions and characteristics of metal film in Comparative Examples.

### DETAILED DESCRIPTION OF THE PREFERRED EMBODIMENTS

The inventors found that an amine protective agent can be removed from a surface of metal fine particle by alkylation of the protective agent coating the surface of the metal fine particle and that a metal film formed of a conductive paste including the metal fine particle has low resistivity compared with a metal film formed of a conventional conductive metal paste, and then, the following invention was completed.

### Embodiment

An embodiment of a metal fine particle, a conductive metal paste and a metal film of the present invention will be described below.

The surface of the metal fine particle of the present embodiment is coated with at least one or more amine compounds as well as one or more compounds which exhibits an effect of alkylation of the amine compounds. Since the surface of the metal fine particle is coated with an amine compound (protective agent) as well as with a compound having an effect of alkylating the amine compound (alkylating agent), the amine compound is alkylated by the heat of calcination and the amine compound as a protective agent is easily eliminated from the surface of the metal fine particle.

Specifically, when an alkyl halide compound is used as a compound having an effect of alkylating an amine compound, the amine compound eventually forms ammonium salt through alkylation reaction. Since an N atom in ammonium salt does not have an unshared electron pair, there is no possibility that the formed ammonium salt is re-adsorbed to the surface of the metal fine particle.

Therefore, the amine compound as a protective agent can be promptly and surely eliminated by calcination at low temperature for short time after the conductive metal paste formed by mixing the metal fine particle of the present embodiment and a solvent composition is applied to an object such as an electronic substrate, and it is possible to form a metal film having lower resistivity than a metal film formed of a conventional conductive metal paste.

The metal fine particle and the conductive metal paste of the present embodiment are used for electronic circuit formation, solder materials, plating materials and wire shielding layer formation, etc.

Metal Fine Particle

One or more metals of Au, Ag, Cu, Pt, Pd, Rh, Ru, Os, Ir, Al, Zn, Sn, Co, Ni, Fe, In, Mg, W, Ti, Ta and Mn can be selected as the type of metal for the above-mentioned metal fine particle. In addition, metal fine particles formed in combination of metal fine particles of plural types of metals or that formed of alloys can be also used.

The average particle size of the metal fine particle can be selected from a range of 1-1000 nm, and is more desirably in a range of 1-100 nm. When the average particle size is 100 nm or less, the melting point depression of the metal fine particle is remarkable and the calcination of the conductive metal paste at low temperature is easy. On the other hand, when the average particle size is more than 1000 nm, although the melting point is the same as that of bulk metal and a certain level of aggregation or sintering occurs, it is not preferable since calcinations at low temperature is difficult in principle. Meanwhile, the shape of the metal fine particle is not specifically limited, and it may be in a spherical shape, a column shape or other shapes. In view of the melting point depression of the metal fine particle, the maximum diameter in a range less than 1000 urn is more desirable, regardless of the shape of the metal fine particle.

The content of the metal fine particle in the conductive metal paste can be selected from a range of 5-90% by mass with respect to the total mass of the conductive metal paste. When the content of the metal fine particle is more than 90% by mass, the viscosity of the conductive metal paste becomes very high, which may adversely affect coating properties. On the other hand, less than 5% by mass of the content is not preferable since it may be difficult to obtain a smooth metal film with less cracks or holes when the conductive metal paste is calcined. The content of the metal fine particle can be appropriately adjusted depending on thickness or paste viscosity of a metal film to be manufactured. The content in a range of 30-80% by mass, which causes less volume shrinkage associated with removal of a solvent composition or a protective agent at the time of calcination and in which it is easy to obtain a smooth metal film, is more desirable.

Amine Compound

The protective agent for coating the surface of the above-mentioned metal fine particle is made of an amine compound as a compound which can be coordinatively adsorbed to the metal fine particle. The amine compound is coordinatively adsorbed on a metal surface using an unshared electron pair of an N atom. Since adsorption strength to the metal fine particle depends on electron density of the unshared electron pair on the N atom of amine, an amine compound having a structure in which the electron density of the unshared electron pair is high is desirable. In detail, a secondary amine (NHR₁R₂) or tertiary amine (NR₁R₂R₃) in which an N atom is bonded to two or more alkyl groups as an electron-donating group is desirable (R₁, R₂ and R₃ are alkyl groups). In further view of removal of amine by alkylation reaction during calcination, a tertiary amine (NR₁R₂R₃) in which all of three bonds of the N atom have been already bonded to alkyl groups is more desirable. The amount of compounds added for alkylation such as an alkyl halide compound can be reduced by using large series of amines.

Preferable length of alkyl group of the amine compound is 2-16 carbons long. Since the boiling point or decomposition temperature of the amine compound is raised when the carbon number is 17 or more, calcination at low temperature is relatively difficult. In addition, the alkyl group is hydrophobic and dispersibility or stability of the metal fine particle in organic solvent varies depending on the length of the alkyl group. A relatively low polarity solvent is often used for conductive metal paste, and in view of this, secondary or tertiary amine which has an alkyl group with a carbon number of about 2-8 as well as has a side-chain structure is desirable. Specifically, bis(2-ethylhexyl)amine and trihexylamine, etc., are included.

Although depending on the type of protective agent, the added amount of the protective agent for coating the surface of the metal fine particle is desirably in a range of 0.1-10% by mass with respect to the mass of the metal fine particle. When less than 0.1% by mass, a ratio of the coated surface of the metal fine particle is decreased and metal fine particles are likely to aggregate. On the other hand, the surface of the metal fine particle is sufficiently coated with the protective agent when the added amount thereof is more than 10% by mass, however, the amount of the alkylating agent added to remove the excessive protective agent is also increased, which may cause significant deterioration of coating properties when being formed into conductive metal paste. It is more desirable that the added amount of the protective agent is 1-5% by mass by which the dispersibility in the conductive paste is increased and the coating properties are not deteriorated despite of addition of the alkylating agent which reacts with the protective agent.

Alkylating Agent

An alkyl halide compound can be preferably used as a compound having an effect of alkylating an amine compound. Alkylation reaction of an amine compound by the alkyl halide compound proceeds as follows. The amine compound on the surface of the metal fine particle is reacted with the alkyl halide compound by heat during calcination and amine is alkylated, which results in that an amine compound having larger series or quaternary amine salt is produced. It is considered that amine is eliminated from the surface of the metal fine particle, during formation of an amine compound having larger series or by eventually forming quaternary amine salt.

Reactivity of alkyl halide with an amine compound varies depending on the type and series of halogen. The level of reactivity with an amine compound depending on the type of halogen is high in order of alkyl iodide, alkyl bromide, alkyl chloride and alkyl fluoride. Meanwhile, the level of reactivity with amine due to deference of series of alkyl halide is high in order of primary alkyl halide, secondary alkyl halide and tertiary alkyl halide. In view of reactivity with amine and in further view of safety of alkyl halide itself, alkyl iodide having a primary structure can be used more preferably.

Alkyl iodide includes iodomethane, iodoethane, 1-iodopropane, 2-iodopropane, 1-iodobutane, 1-iodo-2-methylpropane, 1-iodopentane, 1-iodo-3-methylbutane, 1-iodohexane, 1-iodoheptane, 1-iodooctane, 1-iodononane, 1-iododecane, 1-iodoundecane, 1-iodododecane, 1-iodotridecane, 1-iodotetradecane, 1-iodopentadecane, 1-iodohexadecane, 1-iodoheptadecane, 1-iodooctadecane, 1-iodononadecane and 1-iodoeicosane, etc.

The appropriate added amount of alkyl halide is as follows. The amount of material (mol) of alkyl group to be used is calculated, assuming that an H atom bonded to the N atom of the amine compound present on the surface of the metal fine particle is alkylated, and the alkyl group is coordinatively bonded to an unshared electron pair of the N atom. Although it is only necessary to add the alkyl halide of the mol amount equal to the alkyl group to be used, 1-3 times of the mol amount should be added in order to effectively remove the amine protective agent from the surface of the metal fine particle. Meanwhile, the excessive amount of addition may cause reaction with the amine protective agent before calcination or may damage the coating properties of the conductive metal paste.

Solvent Composition

The type of the above-mentioned solvent composition (solvent) can be selected from the group of water, alcohol, aldehydes, amines, thiols, monosaccharide, polysaccharide, straight-chain hydrocarbons, fatty acids and aromatics, and a combination of plural solvents can be also used. It is desirable that a solvent having an affinity to the amine protective agent for coating the metal fine particle is selected from the above-mentioned group. The amine protective agent adsorbed on the metal fine particle by an unshared electron pair is dispersed into the solvent by an effect of a structure other than N atom involved in adsorption. Therefore, it is likely to be dispersed into water and a polar solvent when the structure other than N atom is hydrophilic, and it is likely to be dispersed into a low polarity solvent and a nonpolar solvent when the structure other than N atom is hydrophobic. It is possible to appropriately select the solvent in view of the above.

Meanwhile, the solvent having a too high affinity to the amine protective agent is not preferable since the amine protective agent adsorbed on the surface of the metal fine particle may be dissolved in the solvent, which results in that the metal fine particle is separated from the solvent. In addition, a combination by which the amine protective agent and the solvent are chemically reacted and are each changed into different compounds should be avoided since it causes aggregation of the metal fine particles.

A low polarity solvent or a nonpolar solvent, which can adjust the conductive metal paste to be appropriate coatable viscosity and has relatively high boiling point so as not to easily vaporize at room temperature, is desirable. Specifically, normal hydrocarbon with a carbon number of 10-16, toluene, xylene, 1-decanol, terpineol, etc., can be preferably used as a solvent composition (solvent). Alternatively, a minute amount of wax or resin as an additive can be added to the solvent in order to control formability and viscosity, etc., of the conductive metal paste.

Silver Oxide Particle

The conductive metal paste obtained by mixing the above-mentioned metal fine particle with a solvent composition can be used with further addition of a silver oxide particle thereto. The addition of the silver oxide particle provides two effects. One of the effects is to enhance decomposition of amine salt. The amine protective agent is alkylated by calcination of the conductive metal paste and amine salt is eventually produced, and in the presence of silver oxide, the amine salt shows Hofmann elimination reaction and changes into amine or alkene. Therefore, the addition of the silver oxide provides active decomposition of the amine salt, which makes easy to obtain a metal film more excellent in conductivity. Another effect is to improve adhesion between the base material on which a metal film is formed and the metal film. When the conductive metal paste is heated, the silver oxide is decomposed at a certain temperature and produces metal silver and oxygen. The silver oxide generates heat during the decomposition and the surrounding of the silver oxide is heated to a higher temperature than the heating temperature. This high temperature provides an effect of improving adhesion of the metal film to the base material. The reason why the adhesion is improved is that a new layer improving adhesion is formed between the metal film and the base material or that an anchor is formed by dispersion of the metal fine particle into the base material.

The added amount of the silver oxide is the molar quantity equal to amine salt to be produced, and more desirably, a slightly excessive amount. This is because an exothermic effect can be expected in addition to the reaction with amine salt. In general, decomposition of silver oxide starts around 160° C. in the air and is accelerated at 250° C. However, the decomposition temperature tends to be further lowered in a reducing solvent. Therefore, it is desirable that a solvent for the conductive metal paste to which silver oxide is added includes weak reducing solvent. Specifically, an alcohol-based compound such as 1-decanol or terpineol can be preferably used as a solvent.

### EXAMPLES

Specific examples of the invention will be described below. Measurement of each physical property in Examples and Comparative Examples was conducted as follows.

### (1) Measurement of Film Thickness and Volume Resistivity of Metal Film

A FE-SEM (field-emission-type scanning electron microscope, S-5000, manufactured by Hitachi, Ltd.) was used for film thickness measurement of metal film. A 4-probe electrical resistance measuring device was used for measuring volume resistivity of the metal film.

### (2) Measurement of Adhesion of Metal Film

Adhesion of the metal film on a Cu substrate was evaluated by a micro-scratch test.

### Example 1

10 g of powder of Ag nanoparticles with an average particle size of 9 nm on which about 1% by mass of bis(2-ethylhexyl)amine as an amine compound is adsorbed was dispersed into 100 mL of toluene solvent, 0.264 g of 1-iodohexane as an alkylating agent was further added thereto, and the solvent was stirred for 30 minutes while maintaining the solvent at 60° C. After stirring, toluene was removed by reduced-pressure distillation, thereby synthesizing Ag nanoparticles having bis(2-ethylhexyl)amine and 1-iodohexane adsorbed thereon. The Ag nanoparticles were dispersed into a tetradecane solvent as a solvent composition so that the metal content is 50% by mass, thereby making a conductive metal paste. A surface of a Cu substrate (1 cm×1 cm) was cleaned with 1% dilute sulfuric acid solution, the conductive metal paste was applied thereto by using a spin coat method, and calcination was carried out at 250° C. for 30 minutes in an electric furnace to form an Ag metal film on the Cu substrate. The thickness of the metal film after the calcination was about 0.20 The result of the resistivity measurement of the metal film was 3 μΩ/cm. The result of the adhesion of the metal film by the micro-scratch test was 12 mN.

### Comparative Example 1

In Comparative Example 1, a conductive metal paste, in which a metal fine particle coated only with an amine protective agent without alkylating agent used for alkylating amine protective agent is dispersed into a solvent, was made and an experiment for comparing with Example 1 was carried out.

Powder of Ag nanoparticles with an average particle size of 9 nm on which about 1% by mass of bis(2-ethylhexyl)amine is adsorbed was dispersed into a tetradecane solvent so that the metal content is 50% by mass, thereby making a conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 20 μm. The result of the resistivity measurement of the metal film was 8 μΩcm. The result of the film adhesion by the micro-scratch test was 7 mN.

In Example 1, since the metal fine particle is coated with the alkylating agent used for alkylating the amine protective agent, the amine protective agent is promptly and sufficiently desorbed and removed during the calcination, and as a result, the resistivity of the metal film in Example 1 is significantly reduced compared with that of the metal film in Comparative Example 1. In addition, the film adhesion of the metal film in Example 1 is greatly improved compared with the metal film in Comparative Example 1.

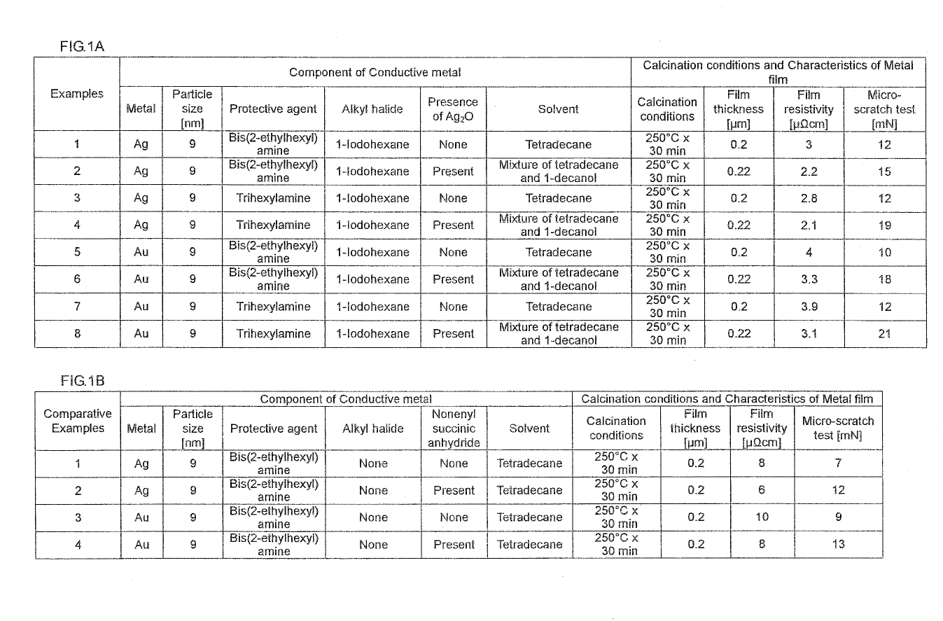

FIG. 1A collectively shows a composition of metal fine particle, a component of conductive metal paste, and calcination conditions and characteristics of metal film in Examples 1-8, and FIG. 1B collectively shows a composition of metal fine particle, a component of conductive metal paste, and calcination conditions and characteristics of metal film in Comparative Examples 1-4.

### Comparative Example 2

In Comparative Example 2, a conductive metal paste known as the conventional art, in which a metal fine particle coated with an amine protective agent and a material for amidation reaction used for the amine protective agent is dispersed into a solvent, was made and experiment for comparing with Example 1 was carried out.

10 g of powder of Ag nanoparticles with an average particle size of 9 nm on which about 1% by mass of bis(2-ethylhexyl)amine is adsorbed was dispersed into 100 mL of toluene solvent, 0.093 g of nonenyl succinic anhydride as a material for amidation reaction was further added thereto, and the solvent was stirred for 30 minutes while maintaining the solvent at 60° C. After stirring, toluene was removed by reduced-pressure distillation, thereby synthesizing Ag nanoparticles having bis(2-ethylhexyl)amine and nonenyl succinic anhydride adsorbed thereon. The Ag nanoparticles were dispersed into a tetradecane solvent so that the metal content is 50% by mass, thereby making a conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.20 μm. The result of the resistivity measurement of the metal film was 6 μΩcm. The result of the film adhesion by the micro-scratch test was 12 mN.

In Comparative Example 2, there is improvement in removal of the amine protective agent compared with Comparative Example 1 since the metal fine particle is coated with nonenyl succinic anhydride (material for amidation reaction), however, the resistivity of the metal film is still large compared with Example 1.

### Example 2

In Example 2, a silver oxide particle is further added to the conductive metal paste of Example 1 and 1-decanol as a solvent composition is further added to tetradecane.

Ag nanoparticles on which bis(2-ethylhexyl)amine and 1-iodohexane are adsorbed were synthesized in the same procedure as Example 1. Tetradecane and 1-decanol as solvent compositions were mixed so that tetradecane is 90% by mass and 1-decanol is 10% by mass. Ag nanoparticle powder and silver oxide particles (average particle size of about 1 μm) were dispersed into the mixed solvent, thereby making a conductive metal paste. The Ag nanoparticle powder is 50% by mass, the silver oxide particle is 3% by mass and the mixed solvent composition is 47% by mass with respect to the total mass of the conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.22 μm. The result of the resistivity measurement of the metal film was 2.2 μΩm. The result of the film adhesion by the micro-scratch test was 15 mN.

In Example 2, since the silver oxide particle is further added to the conductive metal paste of Example 1, decomposition of amine salt eventually produced by alkylation of bis(2-ethylhexyl)amine alkylated by 1-iodohexane is enhanced and the adhesion of the metal film is improved by decomposition heat, resulting in low resistivity and improved adhesion compared with the metal film of Example 1.

### Example 3

In Example 3, the amine compound is changed to trihexylamine from bis(2-ethylhexyl)amine used in Example 1.

10 g of powder of Ag nanoparticles with an average particle size of 9 nm on which about 1% by mass of trihexylamine as an amine compound is adsorbed was dispersed into 100 mL of toluene solvent, 0.157 g of 1-iodohexane was further added thereto, and the solvent was stirred for 30 minutes while maintaining the solvent at 60° C. After stirring, toluene was removed by reduced-pressure distillation, thereby synthesizing Ag nanoparticles having trihexylamine and 1-iodohexane adsorbed thereon. The Ag nanoparticles were dispersed into a tetradecane solvent so that the metal content is 50% by mass, thereby making a conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.20 μm. The result of the resistivity measurement of the metal film was 2.8 μΩcm. The result of the film adhesion by the micro-scratch test was 12 mN. A metal film excellent in resistivity and film adhesion similar to Example 1 was obtained also in Example 3.

### Example 4

In Example 4, a silver oxide particle is further added to the conductive metal paste of Example 3 and 1-decanol as a solvent composition is further added to tetradecane.

Ag nanoparticles on which trihexylamine and 1-iodohexane are adsorbed was synthesized in the same procedure as Example 3. Tetradecane and 1-decanol were mixed so that tetradecane is 90% by mass and 1-decanol is 10% by mass. Ag nanoparticle powder and silver oxide particles (average particle size of about 1 μm) were dispersed into the mixed solvent, thereby making a conductive metal paste. The Ag nanoparticle powder is 50% by mass, the silver oxide particle is 3% by mass and the mixed solvent composition is 47% by mass with respect to the total mass of the conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.22 μm. The result of the resistivity measurement of the metal film was 2.1 μΩcm. The result of the film adhesion by the micro-scratch test was 19 mN.

In Example 4, the resistivity of the metal film is lower than that of the metal film of Example 1 similar to Example 2 in which the silver oxide particle is added, and the adhesion of the metal film is further improved compared with the metal film of Example 2 in which bis(2-ethylhexyl)amine is used.

### Example 5

In Example 5, the type of metal used for the metal fine particle is changed from Ag (silver) used in Example 1 to Au (gold) (an Au nanoparticle is used as a metal fine particle also in Examples 6-8).

10 g of powder of Au nanoparticles with an average particle size of 9 nm on which about 1% by mass of bis(2-ethylhexyl)amine is adsorbed was dispersed into 100 mL of toluene solvent, 0.264 g of 1-iodohexane was further added thereto, and the solvent was stirred for 30 minutes while maintaining the solvent at 60° C. After stirring, toluene was removed by reduced-pressure distillation, thereby synthesizing Au nanoparticles having bis(2-ethylhexyl)amine and 1-iodohexane adsorbed thereon. The Au nanoparticles were dispersed into a tetradecane solvent so that the metal content is 50% by mass, thereby making a conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.20 μm. The result of the resistivity measurement of the metal film was 4 μΩcm. The result of the film adhesion by the micro-scratch test was 10 mN. Although the Au nanoparticle is used as the metal fine particle in Example 5, the obtained metal film has excellent resistivity and film adhesion similar to Example 1 in which the Ag nanoparticle is used.

### Comparative Example 3

In Comparative Example 3, a conductive paste, in which an Au fine particle coated only with an amine protective agent without alkylating agent used for alkylating amine protective agent is dispersed into a solvent, was made and an experiment for comparing with Example 5 was carried out.

Powder of Au nanoparticles with an average particle size of 9 nm on which about 1% by mass of bis(2-ethylhexyl)amine is adsorbed was dispersed into a tetradecane solvent so that the metal content is 50% by mass, thereby making a conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.20 μm. The result of the resistivity measurement of the metal film was 10 μΩcm. The result of the film adhesion by the micro-scratch test was 9 mN. In Comparative Example 3, since the metal fine particle is not coated with the alkylating agent used for alkylating the amine protective agent in the same manner as Comparative Example 1, the resistivity of the metal film is larger than Example 5.

### Comparative Example 4

In Comparative Example 4, a conductive metal paste, in which a metal fine particle coated with an amine protective agent and a material for amidation reaction for alkylating the amine protective agent is dispersed into a solvent, was made and an experiment for comparing with Example 5 was carried out.

10 g of powder of Au nanoparticles with an average particle size of 9 nm on which about 1% by mass of bis(2-ethylhexyl)amine is adsorbed was dispersed into 100 mL of toluene solvent, 0.093 g of nonenyl succinic anhydride as a material for amidation reaction was further added thereto, and the solvent was stirred for 30 minutes while maintaining the solvent at 60° C. After stirring, toluene was removed by reduced-pressure distillation, thereby synthesizing Au nanoparticles having bis(2-ethylhexyl)amine and nonenyl succinic anhydride adsorbed thereon. The Au nanoparticles were dispersed into a tetradecane solvent so that the metal content is 50% by mass, thereby making a conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.20 μm. The result of the resistivity measurement of the metal film was 8 μΩcm. The result of the film adhesion by the micro-scratch test was 13 mN.

In Comparative Example 4, there is improvement in removal of the amine protective agent compared with Comparative Example 3 since the metal fine particle is coated with nonenyl succinic anhydride (material for amidation reaction), however, the resistivity of the metal film is still large compared with Example 5.

### Example 6

In Example 6, a silver oxide particle is further added to the conductive metal paste of Example 5 and 1-decanol as a solvent composition is further added to tetradecane.

Au nanoparticle having bis(2-ethylhexyl)amine and 1-iodohexane adsorbed thereon was synthesized in the same procedure as Example 5. Tetradecane and 1-decanol were mixed so that tetradecane is 90% by mass and 1-decanol is 10% by mass. Au nanoparticle powder and silver oxide particles (average particle size of about 1 μm) were dispersed into the mixed solvent, thereby making a conductive metal paste. The Au nanoparticle powder is 50% by mass, the silver oxide particle is 3% by mass and the mixed solvent composition is 47% by mass with respect to the total mass of the conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.22 μm. The result of the resistivity measurement of the metal film was 3.3 μΩcm. The result of the film adhesion by the micro-scratch test was 18 mN.

In Example 6, the silver oxide particle is further added to the conductive metal paste of Example 5, resulting in low resistivity and improved adhesion compared with the metal film of Example 5.

### Example 7

In Example 7, the amine compound is changed to trihexylamine from bis(2-ethylhexyl)amine used in Example 5.

10 g of powder of Au nanoparticles with an average particle size of 9 nm on which about 1% by mass of trihexylamine is adsorbed was dispersed into 100 mL of toluene solvent, 0.157 g of 1-iodohexane was further added thereto, and the solvent was stirred for 30 minutes while maintaining the solvent at 60° C. After stirring, toluene was removed by reduced-pressure distillation, thereby synthesizing Au nanoparticles having trihexylamine and 1-iodohexane adsorbed thereon. The Au nanoparticles were dispersed into a tetradecane solvent so that the metal content is 50% by mass, thereby making a conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.20 μm. The result of the resistivity measurement of the metal film was 3.9 μΩcm. The result of the film adhesion by the micro-scratch test was 12 mN. A metal film excellent in resistivity and film adhesion similar to Example 5 was obtained also in Example 7.

### Example 8

In Example 8, a silver oxide particle is further added to the conductive metal paste of Example 7 and 1-decanol as a solvent composition is further added to tetradecane.

Au nanoparticle having trihexylamine and 1-iodohexane adsorbed thereon was synthesized in the same procedure as Example 7. Tetradecane and 1-decanol were mixed so that tetradecane is 90% by mass and 1-decanol is 10% by mass. Au nanoparticle powder and silver oxide particles (average particle size of about 1 μm) were dispersed into the mixed solvent, thereby making a conductive metal paste. The Au nanoparticle powder is 50% by mass, the silver oxide particle is 3% by mass and the mixed solvent composition is 47% by mass with respect to the total mass of the conductive metal paste. A surface of a Cu substrate (1 cm×1 cm) was cleaned with 1% dilute sulfuric acid solution, the conductive metal paste was applied thereto by using the spin coat method, and calcination was carried out at 250° C. for 30 minutes in the electric furnace. The thickness of the metal film after the calcination was about 0.22 μm. The result of the resistivity measurement of the metal film was 3.1 μΩcm. The result of the film adhesion by the micro-scratch test was 21 mN.

In Example 8, the resistivity of the metal film is lower than that of the metal film of Example 5 similar to Example 6 in which the silver oxide particle is added, and the adhesion of the metal film is further improved compared with the metal film of Example 6 in which bis(2-ethylhexyl)amine is used.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

1. A metal fine particle, comprising:
one amine compound; and
one compound causing an alkylation of the amine compound, wherein the amine compound and the alkylation causing compound cover a surface of the metal fine particle.

2. The metal fine particle according to claim 1, wherein the alkylation causing compound comprises an alkyl halide compound.

3. The metal fine particle according to claim 2, wherein the alkyl halide compound comprises one of iodomethane, iodoethane, 1-iodopropane, 2-iodopropane, 1-iodobutane, 1-iodo-2-methylpropane, 1-iodopentane, 1-iodo-3-methylbutane, 1-iodohexane, 1-iodoheptane, 1-iodooctane, 1-iodononane, 1-iododecane, 1-iodoundecane, 1-iodododecane, 1-iodotridecane, 1-iodotetradecane, 1-iodopentadecane, 1-iodohexadecane, 1-iodoheptadecane, 1-iodooctadecane, 1-iodononadecane, and 1-iodoeicosane.

4. A conductive metal paste, comprising:
the metal fine particle according to claim 1; and
a solvent.

5. A conductive metal paste, comprising:
the metal fine particle according to claim 1;
a silver oxide particle; and
a solvent.

6. A metal film formed with the conductive metal paste according to claim 4.

7. A metal film formed with the conductive metal paste according to claim 5.

8. The metal fine particle according to claim 1, further comprising an average particle size of 1 to 100 nm.

9. The metal fine particle according to claim 2, wherein the alkyl halide compound comprises one of iodoethane, 1-iodopropane, 1-iodobutane, 1-iodo-2-methylpropane, 1-iodopentane, 1-iodo-3-methylbutane, 1-iodohexane, 1-iodoheptane, 1-iodononane, 1-iodoundecane, 1-iodododecane, 1-iodotridecane, 1-iodotetradecane, 1-iodopentadecane, 1-iodohexadecane, 1-iodoheptadecane, 1-iodooctadecane, 1-iodononadecane, and 1-iodoeicosane.

10. The metal fine particle according to claim 1, wherein the one amine compound is removable through a heating process.

11. The metal fine particle according to claim 10, wherein the heating process occurs at a calcinations temperature of the one amine compound.
